(19) United States
(12) Patent Application Publication
(10) Pub. No.: US 2025/0358764 A1
(43) Pub. Date: Nov. 20, 2025

(54) TECHNIQUES FOR CONFIGURING AN ACCESS STRATUM SECURITY FOR A NON-TERRESTRIAL NETWORK

(71) Applicant: Lenovo (Singapore) Pte. Ltd., Singapore (SG)

(72) Inventors: Andreas Kunz, Ladenburg (DE); Sheeba Backia Mary Baskaran, Friedrichsdorf (DE)

(21) Appl. No.: 18/667,902

(22) Filed: May 17, 2024

(51) Int. Cl. H04W 60/04; H04W 12/06; H04W 12/106; H04W 84/06

(52) U.S. Cl. CPC H04W 60/04; H04W 12/06; H04W 12/106; H04W 84/06

(57) ABSTRACT

Various aspects of the present disclosure relate to transmitting a registration request message and receiving a registration accept message in plaintext, where the registration accept message comprises an authentication token and an access stratum (AS) security command from a satellite. Aspects of the present disclosure relate to transmitting, to the satellite, an AS security mode complete message in response to the AS security command and determining an authentication result based at least in part on the authentication token. Aspects of the present disclosure relate to transmitting, to a network function, a protected non-access stratum (NAS) request message using an AS security context based at least in part on the AS security command, where the protected NAS request message comprises the authentication result and a data packet.

### TECHNICAL FIELD

The present disclosure relates to wireless communications, and more specifically to techniques for code configuring an Access Stratum (AS) security for a non-terrestrial network (NTN).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless device communications, and may include one or more wireless devices, such as UEs, satellites, and/or other network equipment (NE), among other devices, that transmit and/or receive signaling. The wireless communications may include a scenario for UE to satellite communication, with store-and-forward (SF) communication to the 5G core network (5GC) and to an application server and/or application function.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may transmit, to a network function, a registration request message; receive, from the network function, a registration accept message in plaintext, wherein the registration accept message comprises an authentication token and an AS security command from a satellite; transmit, to the satellite, an AS security mode complete message in response to the AS security command; determine an authentication result based at least in part on the authentication token; and transmit, to the network function, a protected non-access stratum (NAS) request message using an AS security context based at least in part on the AS security command, wherein the protected NAS request message comprises the authentication result and a data packet.

Some implementations of the method and apparatuses described herein may receive, from a UE, a registration request message, wherein the registration request message is received via a link comprising a satellite; receive, from a network function, an authentication token for the UE; select security algorithms based on security capabilities of the UE and the satellite, the security algorithms comprising an integrity algorithm and a ciphering algorithm; transmit, to the UE via the satellite, a response message comprising an indication of the security algorithms and a registration accept message in plaintext, wherein the registration accept message comprises the authentication token; and receive, from the UE, a protected NAS request message comprising an authentication result and a data packet.

### BRIEF DESCRIPTION OF THE DRAWINGS

FIG. 1 illustrates an example of a wireless communications system in accordance with aspects of the present disclosure.

FIG. 2 illustrates an example of a protocol stack, in accordance with aspects of the present disclosure.

FIG. 3 illustrates an example of SF satellite operation, in accordance with aspects of the present disclosure.

FIG. 4A illustrates an example of a provisional registration procedure, in accordance with aspects of the present disclosure.

FIG. 4B is a continuation of the procedure illustrated in FIG. 4A.

FIG. 5A illustrates an example of a protected small data transmission procedure, in accordance with aspects of the present disclosure.

FIG. 5B is a continuation of the procedure illustrated in FIG. 5A.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a UE in accordance with aspects of the present disclosure.

FIG. 10 illustrates a flowchart of a method performed by a network function (NF) in accordance with aspects of the present disclosure.

### DETAILED DESCRIPTION

A wireless communications system may support wireless communications for one or more wireless devices, such as UEs, satellites, and/or other NEs, among other devices, that transmit and/or receive signaling. A wireless communication scenario may include UE-to-satellite communication, with SF communication to the 5GC and to an application server and/or application function (AF). Due to satellite mobility for satellited in non-geosynchronous orbits, the availability and stability of the communication link between the UE and the 5GC may raise the issue of the feeder link (i.e., the link between satellite and ground network) being intermittently unavailable.

One issue that may arise from an intermittently unavailable feeder link is that the registration procedure (i.e., the UE registering with the 5GC) may be interrupted or timed out. Conventional registration procedure, and authentication and key agreement procedure, may involve several round trips, which may fail due to time outs because of the intermittent unavailability of the connections. For example, the UE may determine partial availability and use the SF mechanism to send small data. Thus, a consideration is how the UE can send a protected message, e.g., a NAS message embedding a small data packet, to the 5GC via a SF link between one or more satellites without a successful registration and/or without running a full registration and authentication procedure.

Accordingly, aspects of the present disclosure include techniques for enabling a UE and a 5GC to perform, via a SF access network, a provisional one-round-trip procedure for a provisional registration. For instance, the UE may not be fully registered at this point in time and thus may not be eligible to receive terminating data or establish a protocol data unit (PDU) session. In some implementations, for example, a normal 5GC registration procedure is not able to be performed due to time outs of the different registration protocols. Thus, the UE and the network (e.g., 5GC) may generate a provisional NAS key for protecting the NAS signaling, and the UE and the satellite may also use AS security algorithms, e.g., to protect the Radio Resource Control (RRC) signaling.

In some implementations, for example, the UE may receive a token from the 5GC to compute a result from a challenge to authenticate itself when the UE subsequently sends the small data in a NAS message, which may be protected by a provisional NAS key. In certain implementations, the provisional NAS key can be derived without an NAS security mode command (SMC) procedure such as to save one round trip of messages. The network may assign a new token in the acknowledgement of the NAS message for the next time usage.

Thus, in implementations, a provisional security context including NAS keys (e.g., without NAS SMC procedure) and provisional registration can be achieved within one round trip and optionally extended NAS timers to avoid timeouts. In certain implementations, UE authentication is accomplished when sending the protected small data with the provisional security context. For each NAS transmission, the UE may determine an updated security context and can be re-authenticated every time it makes a small data transmission. Accordingly, the small data is protected via the SF network (e.g., depending on the validity time of the token) and the process may be less time sensitive such that a procedure may not need to be carried out within a specific time window.

As used herein, small data transmission refers to the UE embedding user data into a signaling message send to the core network. NAS is used for control plane signaling between the UE and the core network (e.g., 5GC), therefore small data transmission may involve embedding a small data packet within the payload of a NAS message. Because the NAS messages are constrained to a maximum permitted size, which varies depending on the network technology and deployment or configuration, only small amounts of user data are able to be communicated via the control plane signaling. However, this small data transmission technique is suitable for devices with limited capabilities, such as an IoT device that only needs to transmit small amounts of data to a service endpoint (e.g., IoT application server). Beneficially, when only small amounts of data need to be communicated, using the small data transmission techniques allows the UE to transmit the data without the need for dedicated data connections, thereby conserving network resources and improving network efficiency.

By performing the described techniques, the UE can be enabled to send protected data in scenarios where full network registration may not be available, thus increasing data security and system efficiency. However, the provisional registration technique is only related to setup the security on NAS layer but misses to configure the security on AS layer (i.e., between the UE and the eNB/gNB in the satellite) and does not consider how the AS keys in the satellite are configured or omitted to be used.

As described above, the satellite may be moving relative to the earth which causes the unavailability of the UE for some periods and the need for the SF operation. Due to the satellite movement, the next available satellite may not be the same one where the UE connected before, and the satellites may not have interconnection to facilitate context transfer. This complicates the issue if the UE has an AS security context in one satellite and tries to use it with the next satellite, but this next satellite cannot connect to the satellite that has the active AS context. Therefore, an additional mechanism is required so that the satellite and the UE select the same configuration for the AS security.

Various aspects of the present disclosure relate to selecting null protection algorithms to provide the AS security for SF operation with small data transmission. In some implementations, the null encryption algorithm #0 (NEA0) and the null integrity protection algorithm #0 (NIA0) may be used for null ciphering and integrity protection. These algorithms may be indicated to the satellite and the UE in the integrated AS security command as a default configuration for the SF service.

Thus, in implementations, during the transition from idle to connected mode, the UE indicates the SF service also in the RRC request so that NEA0 and NIA0 algorithms are continued to be used. The satellite also indicates the support of AS security for SF service. If AS security for SF service is not supported, the access and mobility management function (AMF) indicates the NEA0 and NIA0 algorithms to the satellite for further usage for the AS security setup. The satellite integrates an AS security mode command together with the NAS registration accept message to the UE to indicate the NEA0 and NIA0 algorithms. At the moment, Third Generation Partnership Project (3GPP) networks only use the NEA0 and NIA0 algorithms for emergency calls and or UEs in limited service mode (LSM). Note that the LSM state typically occurs when the UE is unable to establish a full-service connection with the network, but still has access to certain essential functionalities, such as making emergency calls.

Aspects of the present disclosure are described in the context of a wireless communications system.

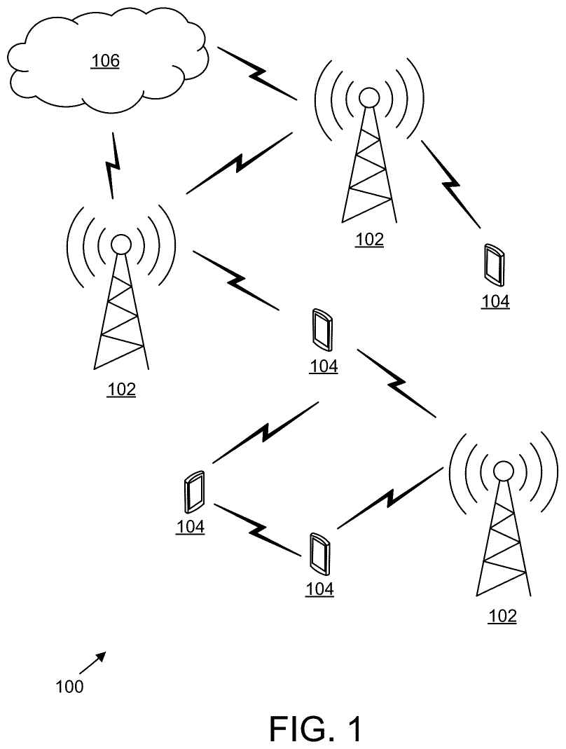

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network.

In other implementations, the wireless communications system 100 may be a combination of a 4G network and a 5G network, or other suitable radio access technology (RAT) including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage NAS functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a PDU session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

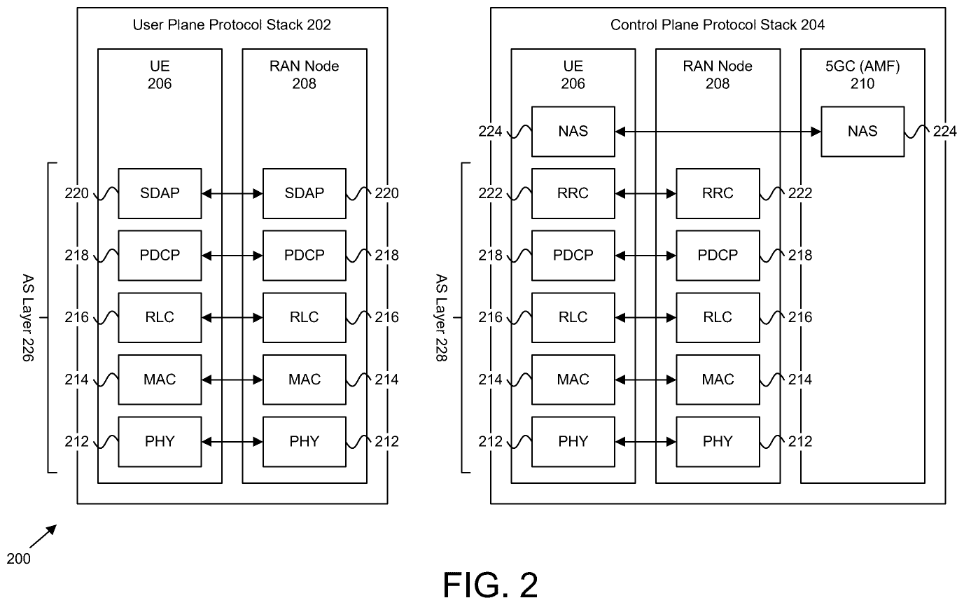

FIG. 2 illustrates an example of a protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a physical (PHY) layer 212, a medium access control (MAC) sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, a RLC sublayer 216, and a PDCP sublayer 218. The control plane protocol stack 204 also includes a RRC layer 222 and a NAS layer 224.

Note that in some transparent satellite architectures, the satellite may act as a repeater, but does not terminate the NR-Uu interface. In some embodiments, the NTN may relay signaling for one or more layers between the UE 206 and the RAN node 208. In other embodiments, the NTN may relay NAS layer signaling between the RAN node 208 and the 5GC 210 (note that NAS singling is transparent to the RAN node 208).

The AS layer 226 (also referred to as “AS protocol stack”) for the user plane protocol stack 202 consists of at least SDAP, PDCP, RLC and MAC sublayers, and the physical layer. The AS layer 228 for the control plane protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 manages the addition, modification, and release of carrier aggregation and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

In the radio protocol architectures described herein, the term “SDU” refers to a data unit that is received by a sublayer from a higher sublayer, or that is sent by a sublayer to a higher sublayer. Likewise, the term “PDU” refers to a data unit that is sent by a sublayer to a lower sublayer, or that is received by a sublayer from a lower sublayer.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

Small data transmission for MTC devices, or IoT devices, was standardized for the evolved packet system (EPS), where the UE can transmit a small data packet inside the protected NAS signaling message. However, in LTE networks, transmitting small data in a protect NAS message requires that a successful registration and authentication procedure takes place in advance of the transmission to generate the relevant NAS key material. As described above, it cannot be assumed that a UE in a SF network is able to achieve full registration and authentication, because of the intermittent unavailability of the UE due to the SF satellite connections.

Accordingly, the UE may provisionally register to the 5GC via the SF link, whereby the UE can be authenticated by bundling the authentication round trip with the NAS SMC in one message. In such a solution, the authentication token may be derived using the normal authentication challenge in 5G-AKA or EAP-AKA′ using preconfigure default values (e.g., for UL Count) so that both sides can derive the whole set of keys for NAS security without waiting for the UE to reply to the authentication challenge.

Further, for AS security, the AMF may indicate the NEA0 and NIA0 algorithms to the satellite for further usage for the AS security setup. The satellite may then integrate an AS security mode command together with the NAS registration accept message to the UE to indicate the NEA0 and NIA0 algorithms, as described in further detail below.

As used herein, NEA0 is a null encryption algorithm used in 3GPP networks, e.g., for communication of non-sensitive control plane signaling messages or for data traffic that is already encrypted at a higher layer of the protocol stack. The NEA0 algorithm does not perform any encryption on the user data payload, but instead passes the data through without applying any cryptographic transformations. However, the use of NEA0 does not pose a security issue in the small data transmission scenario because the small data packet is protected using the NAS keys.

As used herein, NIA0 is a null integrity protection algorithm used in 3GPP networks, e.g., for communication of non-sensitive data or for data that already has integrity protection by higher-layer integrity mechanisms. The NIA0 algorithm does not compute or verify integrity protection codes (such as Message Integrity Codes or MICs) for the user data payload. As a result, the integrity of the data is not ensured by NIA0, and the data could be susceptible to modification or tampering during transmission. However, the use of NIA0 does not pose a security issue in the small data transmission scenario because the small data packet is protected using the NAS keys.

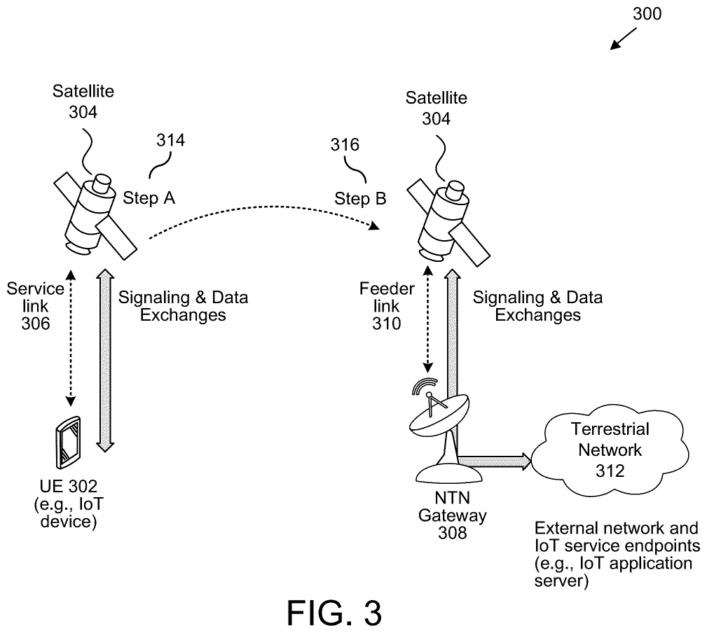

FIG. 3 illustrates an example of SF satellite operation 300, in accordance with aspects of the present disclosure. The SF satellite operation 300 involves a UE 302 which connects to a satellite 304 via a service link 306. Additionally, the satellite 304 connects to an NTN gateway 308 via a feeder link 310. The NTN gateway 308 is a satellite ground/earth device that facilitates communication with a terrestrial network 312, such as the 5GC 210. Here, it is assumed that the satellite 304 supports SF communication.

As used herein, SF operation refers to the satellite 304 receiving signaling and/or data from the UE 302, storing it temporarily in onboard memory, and then forwarding the signaling/data to the terrestrial network 312 once an appropriate connection is available with the NTN. Due to satellite mobility, the UE 302 may connect to various satellites 304 and a respective satellite 304 may switch between different NTN gateways 308. However, during switchover from one NTN gateway 308 to another, the satellite 304 may not always have a connection (e.g., feeder link 310) to an NTN gateway 308.

Accordingly, the SF operation allows a respective satellite 304 to retain the signaling/data from the UE 302 until the satellite 304 can establish a feeder link 310 to an NTN gateway 308. Once the satellite 304 establishes a feeder link 310 with a respective NTN gateway 308, the satellite 304 may forward the stored signaling/data packets to the terrestrial network 312. From there, the data can be routed to its final destination, such as an external network and/or application server. In one embodiment, the UE 302 may comprise an IoT device, wherein the satellite 304 and NTN gateway 308 facilitate signaling and data exchanges with IoT service endpoints (e.g., an IoT application server) in the terrestrial network 312. Beneficially, SF operation allows an NTN to improve reliability when latency and/or intermittent connectivity would otherwise disrupt signaling and data exchanges between the UE and a service endpoint in the terrestrial network 312.

In one or more implementations, the SF satellite operation 300 in a wireless communications system with satellite access provides a communication service for UEs 302 under satellite coverage with intermittent or temporary satellite connectivity (e.g., when the satellite 304 is not connected via a feeder link 310 or via inter satellite links (ISL) to the ground network, e.g., the NTN gateway 308) for a delay-tolerant communication service. In this example of SF satellite operation 300, the end-to-end exchange of signaling and/or data traffic can be handled as a combination of two steps, indicated as step A and step B, not concurrent in time.

For example, at Step A 314, a signaling and/or data exchange between the UE 302 (e.g., one embodiment of the UE 104) and a satellite 304 takes place, without the satellite 304 being simultaneously connected to the ground network (i.e., the satellite 304 operates the service link 306 without an active feeder link 310).

At Step B 316, connectivity between the satellite 304 and the NTN gateway 308 is established so that communication between the satellite 304 and the terrestrial network 312 can take place. In certain embodiments, the satellite 304 moves from being connected to the UE 302 in step A to being connected to the NTN gateway 308 in step B. The concept of SF service (also referred to as S&F service) is used in communication scenarios for delay-tolerant networking and disruption-tolerant networking. In a 3GPP context, a similar service is short message service (SMS), for which there is no need to have an end-to-end connectivity between the endpoints (e.g., an endpoint can be a UE and the other an application server) but only between the endpoints a message service center that operates as an intermediate node for storing and relaying data.

The satellite mobility may cause the unavailability of the UE for some periods and the need for the SF operation. Due to the satellite movement, the next available satellite may not be the same one with which the UE was previously in communication with, and the satellites may not have interconnection. The lack of inter-satellite connection complicates the AS security because the UE may have an AS security context with one satellite and may try to use it with the next satellite, but this next satellite cannot connect to the previous satellite which has the active AS context. In such situations, the UE and satellites cannot use the active AS context to protect signaling at the AS level.

For this reason, the RRC security setup may be omitted for small data transmission with SF operation, since the UE already has a NAS security in place and the small data that is sent from the UE in SF manner is already protected within the NAS message. The NEA0 and NIA0 algorithms for null ciphering and integrity protection are indicated to the satellite and the UE in the integrated AS security command as a default configuration for the SF service. During the transition from idle to connected mode, the UE indicates the SF service also in the RRC request so that NEA0 and NIA0 algorithms are continued to be used.

Aspects of the present disclosure include techniques for enabling a UE and a 5GC to perform, via a SF access network, a provisional one-round-trip procedure for a provisional registration which can enable the UE to send data (e.g., small data) in a protected way. In at least some implementations the described solutions can be split into two parts, the provisional registration procedure and the small data transmission within a NAS message, including the authentication response token.

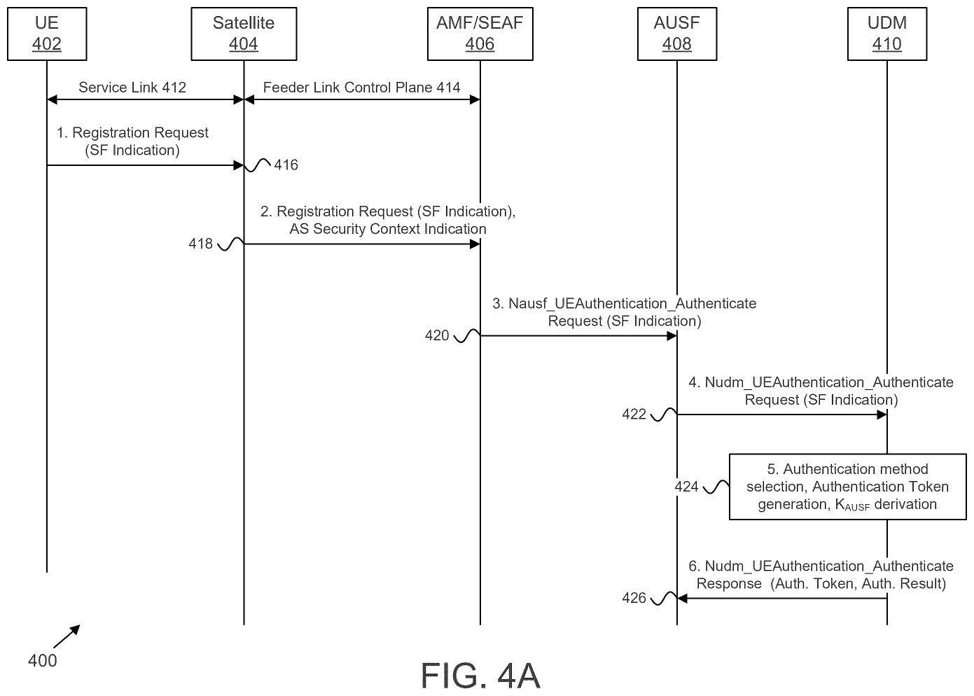

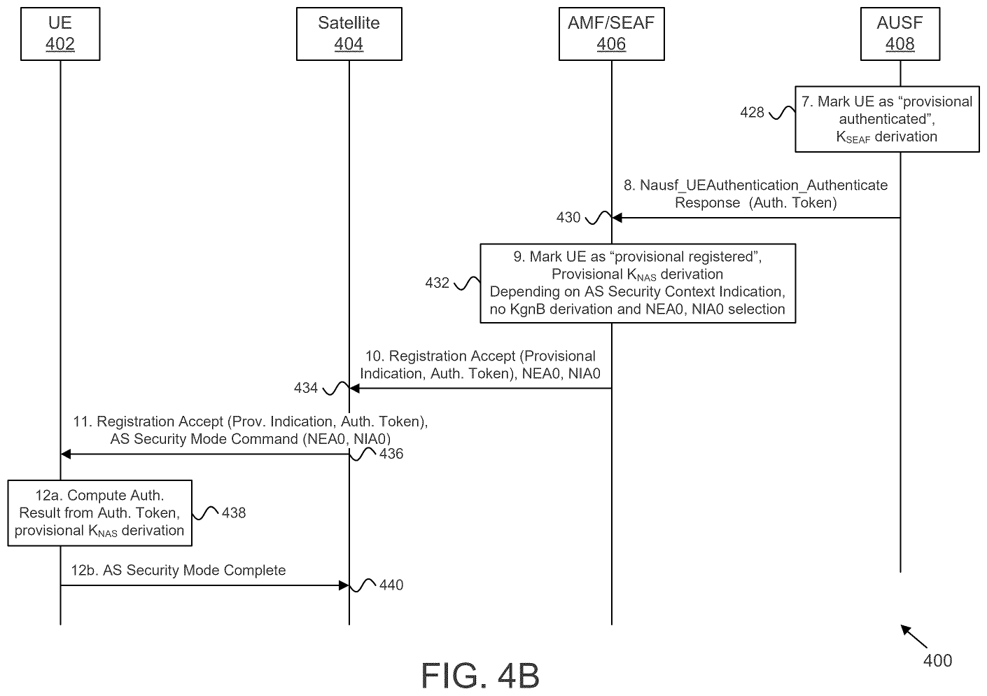

FIGS. 4A and 4B depict an exemplary signaling flow for a provisional registration procedure 400, in accordance with aspects of the present disclosure. The provisional registration procedure 400 involves a UE 402, a serving satellite 404 (e.g., supporting SF operation), an AMF 406, an Authentication Server Function (AUSF) 408, and a Unified Data Management (UDM) 410. While the signaling flow is discussed with reference to the AMF 406, the AMF 406 may additionally or alternatively be implemented as a SEcurity Anchor Function (SEAF). The provisional registration procedure 400 also involves several communication links, such as a service link 412 between the UE 402 and the serving satellite 404 and a feeder link control plane 414 between the serving satellite 404 and the AMF 406. Note that the feeder link control plane 414 supports an N2 Service Access Point (SAP) interface between the satellite 404 and the AMF 406.

In one or more implementations, the UE 402 (at Step 1) transmits a NAS Registration Request message to the SF satellite network (see signaling 416). The UE 402 may include an indication for the AMF 406 that the registration is via SF and not a normal registration procedure. In certain embodiments, the NAS timer for the Registration message is longer than usual for normal registrations to ensure the timer does not expire until the response message is received later. Note that the UE 402 transmits an RRC request message to the satellite 404 first before sending the NAS Registration Request message. In certain embodiments, this first RRC message indicates the SF service so that the satellite 404 knows that no AS security is required. In other embodiments, the RRC request message does not include an indication of SF service because the UE is performing a registration procedure and may not be aware whether the satellite 404 supports SF operation.

At Step 2, the satellite 404 forwards the NAS Registration Request message to the AMF 406 once the feeder link becomes available (see signaling 418). The NAS Registration Request message is encapsulated in a N2 message and the N2 message from the satellite 404 to the AMF 406 may contain an additional indication that an AS security context is supported by the satellite 404.

At Step 3, the AMF 406 transmits an Nausf_UEAuthentication_Authenticate Request message to the AUSF 408, which includes the indication that the registration is via SF network (see signaling 420).

At Step 4, the AUSF 408 transmits an Nudm_UEAuthentication_Get Request message to the UDM 410, which includes the indication that the registration is via SF network (see signaling 422).

At Step 5, the UDM 410 selects the authentication mode and creates an authentication token for the UE 402 (see block 424). The authentication token, for instance, may be the form of the authentication challenge of EAP-AKA′ (Extensible Authentication Protocol, Authentication and Key Agreement), 5G-AKA (Fifth Generation Authentication and Key Agreement), or any other token that can be computed by the UE 402 to produce an expected result in a similar way as in the UDM 410. The UDM 410 derives the AUSF key (K_{A}US_{F}) based on the selected authentication token and computes an expected authentication result.

At Step 6, the UDM 410 transmits an Nudm_UEAuthentication_Get Response message to the AUSF 408, which includes the authentication token and the authentication result (see signaling 426).

Continuing at FIG. 4B, the AUSF 408 (at Step 7) marks the UE 402 as provisional authentication based on the indication that the registration is via SF network and the authentication token (see block 428). Additionally, the AUSF 408 derives the SEAF key (K_{SEAF}) from the key K_{AUSF}.

At Step 8, the AUSF 408 transmits an Nausf_UEAuthentication_Authenticate Response message to the AMF 406, which includes the authentication token (see signaling 430).

At Step 9, the AMF 406 derives the AMF key (K_{AMF}) and the provisional NAS keys, such as without performing a NAS SMC procedure (see block 432). Additionally, the AMF 406 marks the UE 402 as provisional registered. The UE 402, for instance, can send small data in protected NAS messages but cannot receive terminating services since the UE 402 does not have a PDU Session and would not get paged by the AMF 406.

In some embodiments, a default algorithms for integrity and confidentiality may be preconfigured in the AMF 406 and the UE 402. Also at Step 9, the AMF 406 may derive the gNB key (K_{gNB}) based at least in part on whether or not the AMF 406 received (i.e., in step 2) an indication that AS security context is supported by the satellite 404.

If the indication was received in step 2, then the AMF 406 selects default algorithms for ciphering and integrity protection based on the UE 5G security capabilities configuration for SF service. However, if the indication in step 2 is missing, or set to not supported, then the AMF 406 may not derive the key K_{gNB} and may instead select null ciphering and integrity algorithms, e.g., the algorithms NEA0 for confidentiality and NIA0 for integrity protection.

As used herein, if the satellite 404 supports the AS security context, it means that the satellite 404 can derive the AS keys for RRC and user plane, thus it needs to retrieve the K_{gNB} from the AMF 406 to do so. In other embodiments, the satellite 404 may always apply the null algorithms (e.g., NEA0 and NIA0), as this is easier than transferring the AS context when one satellite moves away, but another one is later available for the UE. Note that to handle the AS security context, the satellite 404 requires a secure memory to store the keys. In contrast, when null algorithms are used, the satellite 404 does not need to store keys or key material in secure memory.

At Step 10, the AMF 406 may transmit a NAS Registration Accept message to the UE 402 via the SF satellite 404, which message includes the authentication token and an indication that the registration is provisional (see signaling 434). The NAS Registration Accept message is encapsulated in a N2 message and the N2 message from the AMF 406 to the satellite 404 may contain (or indicate) the selected algorithms for ciphering and integrity protection (e.g., NEA0, NIA0). Depending on the selected algorithms, this N2 message may also contain the key K_{gNB} for protecting the radio interface.

At Step 11, the satellite 404 transmits the Registration Accept to the UE 402, which includes an indication that the registration is provisional and the authentication token (see signaling 436). Additionally, the satellite 404 generates an AS security mode command (SMC) message and includes it in the message towards the UE 402.

Depending on the N2 message from the AMF 406, the satellite 404 may derive further the AS keys K_{RRCint} (i.e., for integrity protection) and K_{RRCene} (i.e., for encryption/confidentiality). Note that in the case where the key K_{gNB} is present in the N2 message, the satellite 404 would derive these AS keys. However, for the case where NIA0 and NEA0 are indicated by the AMF 406 as the default algorithms, then the satellite 404 would not derive these AS keys.

At Step 12a, the UE 402 computes the authentication result from the authentication token (see block 438). The UE 402, for instance, may compute the keys in the same way as the 5GC, e.g., including the provisional NAS keys, with the same default configuration. The NAS keys are then used to protect the NAS message sent via the SF links including the embedded small data.

Depending on the algorithms included in the AS SMC message from the satellite, the UE 402 may derive a K_{gNB} and, i.e., in case NIA0 and NEA0 are not indicated by the satellite. For example, in the case where NIA0 and NEA0 are not indicated by the AS SMC message as the default algorithms, the UE 402 would derive the key K_{gNB}, further derive the AS keys K_{RRCint}, K_{RRCene}. However, for the case where NIA0 and NEA0 are indicated by the AS SMC message as the default algorithms, then the UE 402 would not derive the key K_{gNB} or the AS keys.

At Step 12b, the UE 402 may send an AS security mode complete message to the satellite 404 in response to receiving the SMC message from the satellite 404 in Step 11 (see signaling 440).

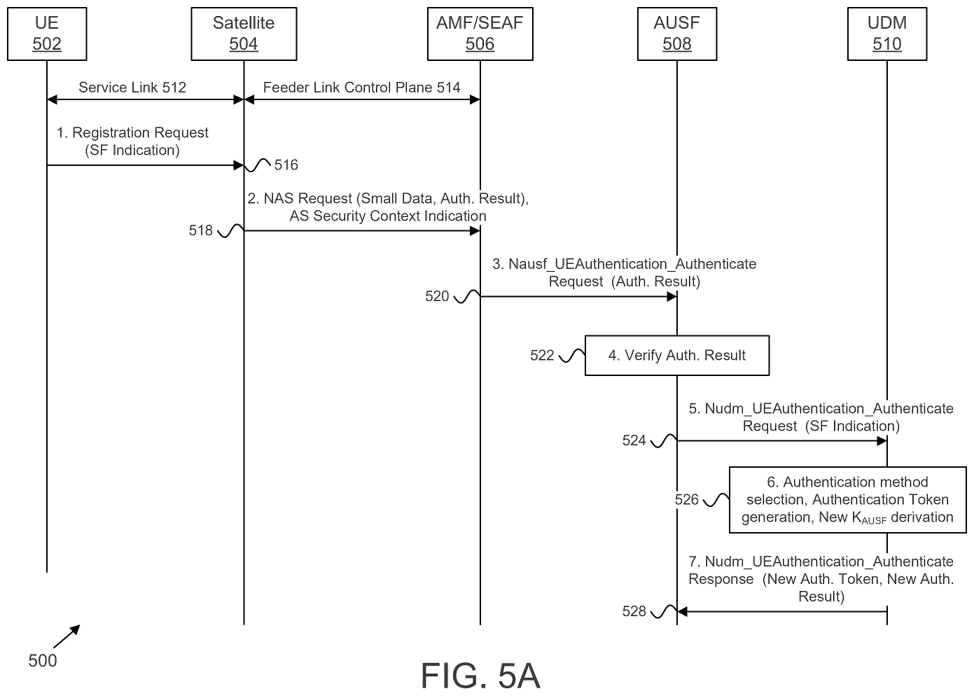

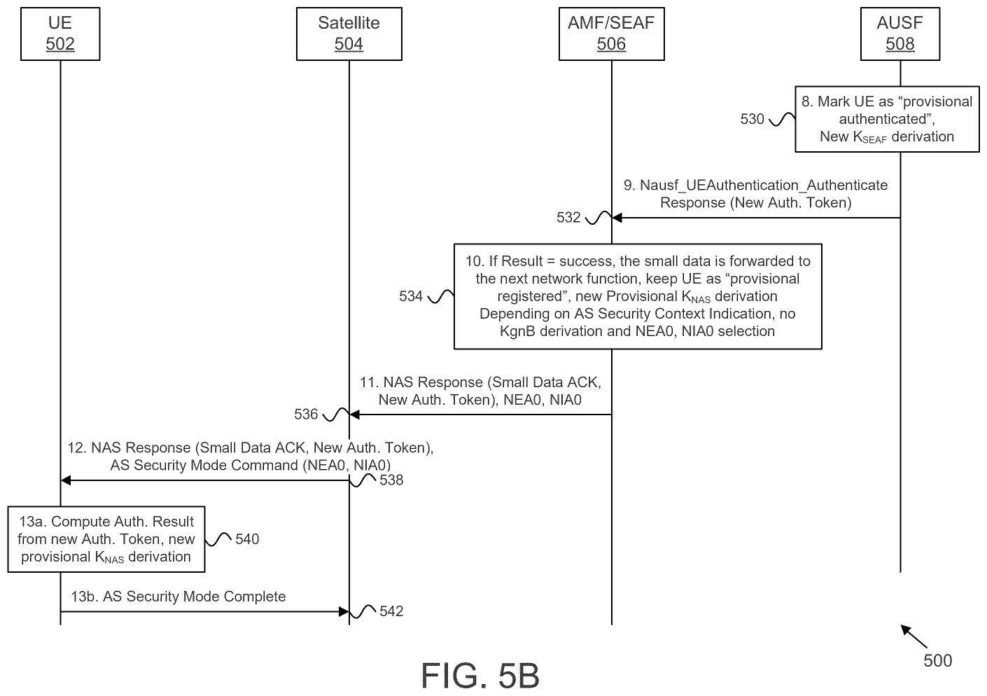

FIGS. 5A and 5B depict an exemplary signaling flow for a small data transmission procedure 500, in accordance with aspects of the present disclosure. The small data transmission procedure 500 involves a UE 502, a serving satellite 504 (e.g., supporting SF operation), an AMF 506, an AUSF 508, and a UDM 510. While the signaling flow is discussed with reference to the AMF 506, the AMF 506 may additionally or alternatively be implemented as an SEAF. In some embodiments, the UE 502 is an implementation of the UE 402, the AMF 506 is an implementation of the AMF 406, the AUSF 508 is an implementation of the AUSF 408, and the UDM 510 is an implementation of the UDM 410. Note that the satellite 404 may be the same satellite used to provisionally register the UE 502, or it may be a different satellite.

The small data transmission procedure 500 may also involve several communication links, such as a service link 512 between the UE 502 and the serving satellite 504 and a feeder link control plane 514 between the serving satellite 504 and the AMF 506. Note that the feeder link control plane 514 supports an N2 SAP interface between the satellite 504 and the AMF 506. The small data transmission procedure 500 depicted in FIGS. 5A-5B, for instance, is assumed to occur after the provisional registration procedure 400 depicted in FIGS. 4A-4B.

In one or more implementations, the UE 502 (at Step 1) sends a protected NAS Request to the SF satellite network (see signaling 516). The UE 502 includes the authentication result, i.e., computed from the authentication token, and small data packet (e.g., compliant with small data transmission protocols).

In some embodiments, the UE 502 may transition from RRC_INACTIVE state to RRC_CONNECTED state and connect to the same last serving satellite 504 which sent the UE 502 into RRC_INACTIVE state or to a different serving satellite 504. In other embodiments, the UE 502 may send the small data directly after the provisional registration procedure 400 depicted in FIGS. 4A-4B, thus the UE 502 and the serving satellite 504 (i.e., the same satellite involved with the provisional registration) would hold the same AS context. As used herein, the AS security context refers to the security parameters and information established during the authentication and key agreement process between the UE and the 5GC. The AS security context may include the authentication token, a UE identity, cryptographic keys, and information about the algorithms for securing the communication.

In case the UE 502 connects to a different satellite 504 and interconnection links between the satellites are available, the UE 502 may perform a handover procedure, such as the procedure described in clause 6.8.2.1.3 of 3GPP technical specification (TS) 33.501 (“State transition from RRC_INACTIVE to RRC_CONNECTED to a new gNB/ng-eNB”). Otherwise, if satellite interconnection links are not available, then the UE 502 does not hold the same AS security context as the serving satellite 504. Accordingly, since the satellite 504 may not hold the AS security context established during registration, the UE 502 may indicate SF service in the RRC request message and uses the algorithms NEA0 for confidentiality and NIA0 for integrity as a default configuration. Note that the UE 502 transmits an RRC request message to the satellite 504 first before sending a NAS message. This first RRC message indicates the SF service so that the satellite 504 knows that no AS security is required, and it does not need to search an AS context.

Additionally, the UE 502 may protect the contents of the NAS message using the provisional NAS keys. To support SF operation, the NAS timer for the NAS message may be much longer than usual for normal NAS messaging to ensure the NAS timer does not expire until the response message is received later.

At Step 2, the satellite 504 transmits the NAS Request message to the AMF 506 (see messaging 518). The NAS Request message is encapsulated in a N2 message and the N2 message from the satellite 504 to the AMF 506 may contain an additional indication that an AS security context is supported by the satellite 504.

At Step 3, the AMF 506 may transmit an Nausf_UEAuthentication_Authenticate Request message to the AUSF 508, including the authentication result (see messaging 520).

At Step 4, the AUSF 408 verifies the received authentication result, e.g., by comparing the result provided by the UE 502 with one received from the UDM 510 in the provisional registration procedure (see block 522). If the verification is successful, the AUSF 508 maintains the UE 502 as provisionally authenticated and requests a fresh authentication token from the UDM 510.

At Step 5, to request a new authentication token, the AUSF 508 transmits an Nudm_UEAuthentication_Get Request message to the UDM 510, which includes an indication that the registration is via an SF network (see messaging 524). In some embodiments, the AUSF 508 may include the verification result in the request message.

At Step 6, the UDM 510 selects the authentication mode and creates a new authentication token for the UE 502 (see block 526). The authentication token, for instance, may be the form of the authentication challenge of EAP-AKA′, 5G-AKA, or any other token that can be computed by the UE 502 to produce an expected result in a similar way as in the UDM 510. The UDM 510 derives the new key K_{AUSF} based on the selected authentication token and computes an expected authentication result.

At Step 7, the UDM 510 transmits an Nudm_UEAuthentication_Get Response message to the AUSF 508, which includes the new authentication token and the new authentication result (see messaging 528).

Continuing at FIG. 5B, the AUSF 508 (at Step 8) maintains the UE 502 marked as provisional authentication based on the indication that the registration is via SF network and the new authentication token (see block 530). Additionally, the AUSF 508 may derive the new K_{SEAF} from the K_{AUSF}.

At Step 9, the AUSF 508 transmits a Nausf_UEAuthentication_Authenticate Response message to the AMF 506, which includes the new authentication token and the verification result (see block 532).

At Step 10, the AMF 506 forwards the small data to the respective NF if the verification result is successful (see block 534). For example, the AMF 506 may extract the embedded small data packet from the NAS message payload. The respective NF may then take appropriate actions based on the content of the embedded data, such as triggering specific services or forwarding the data to external networks.

Additionally, the AMF 506 derives the new K_{AMF} and the new provisional NAS keys, such as without performing a NAS SMC procedure. The UE 502 is marked in the AMF 506 as provisional registered. For instance, the UE 502 can send small data in the protected NAS messages but cannot receive any terminating services since it does not have a PDU Session and would not get paged by the AMF 506.

In some embodiments, the default algorithms for integrity and confidentiality may be preconfigured in the AMF 506 and UE 502. Also at Step 10, the AMF 506 may derive the key K_{gNB} based at least in part on whether or not the AMF 506 received (i.e., in step 2) an indication that AS security context is supported by the satellite 504.

If the indication was received in step 2, then the AMF 506 selects default algorithms for ciphering and integrity protection based on the UE 5G security capabilities configuration for SF service. However, if the indication in step 2 is missing, or set to not supported, then the AMF 506 may not derive the key K_{gNB} and may instead select null ciphering and integrity algorithms, e.g., the algorithms NEA0 for confidentiality and NIA0 for integrity protection.

At Step 11, the AMF 506 transmits a NAS Response message to the UE 502 via the SF satellite 504, which message is protected with the old provisional NAS keys and includes an acknowledgement for the small data and the new authentication token (see signaling 536). The AMF 506 may delete the old NAS keys after the protection of this message, also considering the NAS retransmission timers.

The NAS Response message is encapsulated in a N2 message and the N2 message from the AMF 506 to the satellite 504 may contain (or indicate) the new selected algorithms for ciphering and integrity protection (e.g., NEA0, NIA0). Depending on the selected algorithms, this N2 message may also contain the new key K_{gNB} for protecting the radio interface.

At Step 12, the satellite 504 transmits the NAS Response message to the UE 502, which includes the acknowledgement for the small data and the new authentication token (see signaling 538). Additionally, the satellite 504 generates a new AS SMC message and includes it in the message towards the UE 502.

Depending on the N2 message from the AMF 506, the satellite 504 may derive further the AS keys K_{RRCint} (i.e., for integrity protection) and K_{RRCene} (i.e., for encryption/confidentiality). Note that in the case where the key K_{gNB} is present in the N2 message, the satellite 504 would derive these AS keys. However, for the case where NIA0 and NEA0 are indicated by the AMF 506 as the default algorithms, then the satellite 504 would not derive these AS keys.

At Step 13a, the UE 502 computes the new authentication result from the new authentication token (see block 540). The UE 502 computes the new keys, such as in the same way as the 5GC, e.g., including the provisional NAS keys, with the same default configuration. The new NAS keys can then be used to protect the next NAS message sent via the SF links including the embedded small data. The UE 502 may delete the old NAS keys after the successful reception of the NAS Response message.

Depending on the algorithms included in the AS SMC message from the satellite, the UE 502 may derive a K_{gNB} and, i.e., in case NIA0 and NEA0 are not indicated by the satellite. For example, in the case where NIA0 and NEA0 are not indicated by the new AS SMC message as the default algorithms, the UE 502 would derive the key K_{gNB}, further derive the AS keys K_{RRCint}, K_{RRCene}. However, for the case where NIA0 and NEA0 are indicated by the AS SMC message as the default algorithms, then the UE 502 would not derive the key K_{gNB} or the AS keys.

At Step 13b, the UE 502 may send an AS security mode complete message to the satellite 504 in response to receiving the SMC message from the satellite 404 in Step 11 (see signaling 542).

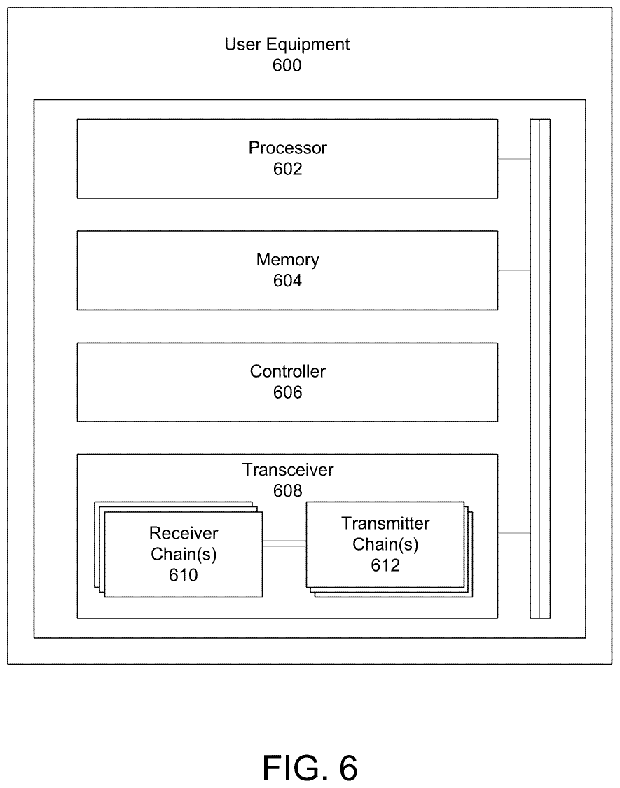

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field programmable gate array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions that, when executed by the processor 602, cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the UE functions described herein (e.g., executing, by the processor 602, instructions stored in the memory 604). Accordingly, the processor 602 may support wireless communication at the UE 600 in accordance with examples as disclosed herein.

For example, the UE 600 may be configured to support a means for transmitting, to a network function (e.g., the AMF), a registration request message. The UE 600 may be configured to support a means for receiving, from the network function, a registration accept message in plaintext, where the registration accept message comprises an authentication token and an AS security command from a satellite. As used herein, the term “plaintext” refers to contents that are unencrypted and unprotected.

In some embodiments, the registration accept message further comprises an indication for using a null integrity algorithm (e.g., the NIA0 algorithm) and a null ciphering algorithm (e.g., NEA0 algorithm) to protect the NAS request message. In some embodiments, the satellite is a S&F satellite, and the registration accept message indicates a provisional registration of the UE.

The UE 600 may be configured to support a means for transmitting, to the satellite, an AS security mode complete message in response to the AS security command. The UE 600 may be configured to support a means for determining an authentication result based at least in part on the authentication token.

The UE 600 may be configured to support a means for transmitting, to the network function (e.g., via the same or a different satellite), a protected NAS request message using an AS security context based at least in part on the AS security command. In such embodiments, the protected NAS request message comprises the authentication result and a data packet.

In some embodiments, the UE 600 is configured to: A) receive a protected NAS response message from the network function, wherein the protected NAS response message comprises a second authentication token and a second AS security command; B) determine a second authentication result based at least in part on the second authentication token; and C) transmit a second AS security mode complete message in response to the second AS security command.

In certain embodiments, the protected NAS response message further comprises an algorithm selection for an integrity algorithm and a ciphering algorithm to protect one or more subsequent NAS messages.

In some embodiments, the UE 600 is configured to: A) transition to an inactive mode (e.g., RRC_INACTIVE state) after transmitting the AS security mode complete message; B) enter a connected mode (e.g., RRC_CONNECTED state) prior to transmitting the protected NAS request message; and C) applying a default integrity algorithm (e.g., the NIA0 algorithm) and a default ciphering algorithm (e.g., the NEA0 algorithm) to protect the NAS request message in response to determining that the UE is connected to a different satellite after entering the connected mode.

The controller 606 may manage input and output signals for the UE 600. The controller 606 may also manage peripherals not integrated into the UE 600. In some implementations, the controller 606 may utilize an operating system (OS) such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding/processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

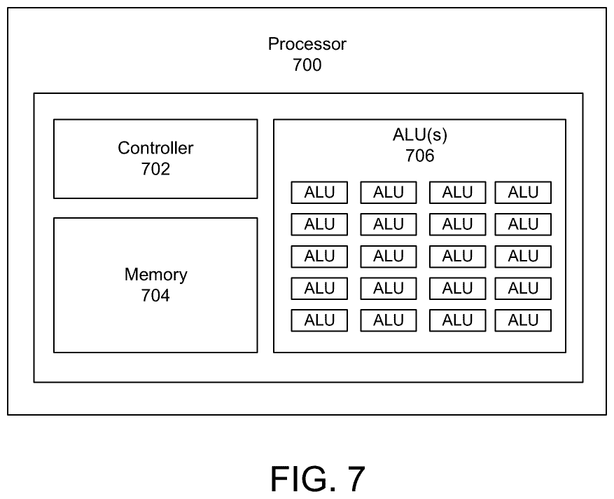

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

In various implementations, the processor 700 may support the functions of a UE, in accordance with examples as disclosed herein. For example, the processor 700 may be configured to support a means for transmitting, to a network function (e.g., the AMF), a registration request message.

The processor 700 may be configured to support a means for receiving, from the network function, a registration accept message in plaintext, where the registration accept message comprises an authentication token and an AS security command from a satellite.

In some embodiments, the registration accept message further comprises an indication for using a null integrity algorithm (e.g., the NIA0 algorithm) and a null ciphering algorithm (e.g., NEA0 algorithm) to protect the NAS request message. In some embodiments, the satellite is a S&F satellite, and the registration accept message indicates a provisional registration of the UE.

The processor 700 may be configured to support a means for transmitting, to the satellite, an AS security mode complete message in response to the AS security command. The processor 700 may be configured to support a means for determining an authentication result based at least in part on the authentication token.

The processor 700 may be configured to support a means for transmitting, to the network function (e.g., via the same or a different satellite), a protected NAS request message using an AS security context based at least in part on the AS security command. In such embodiments, the protected NAS request message comprises the authentication result and a data packet.

In some embodiments, the processor 700 is configured to: A) receive a protected NAS response message from the network function, wherein the protected NAS response message comprises a second authentication token and a second AS security command; B) determine a second authentication result based at least in part on the second authentication token; and C) transmit a second AS security mode complete message in response to the second AS security command.

In certain embodiments, the protected NAS response message further comprises an algorithm selection for an integrity algorithm and a ciphering algorithm to protect one or more subsequent NAS messages.

In some embodiments, the processor 700 is configured to: A) transition to an inactive mode (e.g., RRC_INACTIVE state) after transmitting the AS security mode complete message; B) enter a connected mode (e.g., RRC_CONNECTED state) prior to transmitting the protected NAS request message; and C) applying a default integrity algorithm (e.g., the NIA0 algorithm) and a default ciphering algorithm (e.g., the NEA0 algorithm) to protect the NAS request message in response to determining that the UE is connected to a different satellite after entering the connected mode.

In various implementations, the processor 700 may support the functions of an AMF, in accordance with examples as disclosed herein. For example, the processor 700 may be configured to support a means for receiving, from a UE, a registration request message, wherein the registration request message is received via a link comprising a satellite.

The processor 700 may be configured to support a means for receiving, from a network function (e.g., the AUSF), an authentication token for the UE. The processor 700 may be configured to support a means for selecting security algorithms based on security capabilities of the UE and the satellite, the security algorithms comprising an integrity algorithm and a ciphering algorithm.

The processor 700 may be configured to support a means for transmitting, towards the UE via the satellite, a response message (e.g., an N2 message) comprising an indication of the security algorithms and a registration accept message in plaintext, wherein the registration accept message comprises the authentication token.

The processor 700 may be configured to support a means for receiving, from the UE (e.g., via the same or a different satellite), a protected NAS request message comprising an authentication result and a data packet.

In some embodiments, the at least one processor is configured to: A) transmit, to the network function (e.g., AUSF), an authentication request message comprising the authentication result; B) receive an authentication response message comprising a verification result; and C) forward the data packet to a second network function based on the verification result.

In certain embodiments, the authentication response message further comprises a second authentication token. In such embodiments, the processor 700 may be configured to transmit a NAS response message comprising the second authentication token and an acknowledgement for the data packet. In certain embodiments, the NAS response message may further indicate a second integrity algorithm and a second ciphering algorithm to protect one or more subsequent NAS messages.

In certain embodiments, the registration accept message indicates a provisional registration of the UE, and the NAS request message is protected with a provisional NAS key associated with the provisional registration. In such embodiments, the processor 700 may be configured to protect the NAS response message using the provisional NAS key.

In some embodiments, the processor 700 may be configured to: A) receive an indication that the satellite supports an AS security context; and B) derive a security key for generating AS keys, based on the indication, where the response message comprises the security key.

In some embodiments, the processor 700 may be configured to: A) determine that the satellite lacks support for an AS security context; and B) select a null integrity algorithm (e.g., the NIA0 algorithm) and a null ciphering algorithm (e.g., the NEA0 algorithm) as the security algorithms, based on the indication.

In some embodiments, the satellite is a S&F satellite, and the response message further indicates a default integrity algorithm (e.g., the NIA0 algorithm) and a default ciphering algorithm (e.g., the NEA0 algorithm) to protect the NAS request message when a communication path to the UE comprises a different satellite.

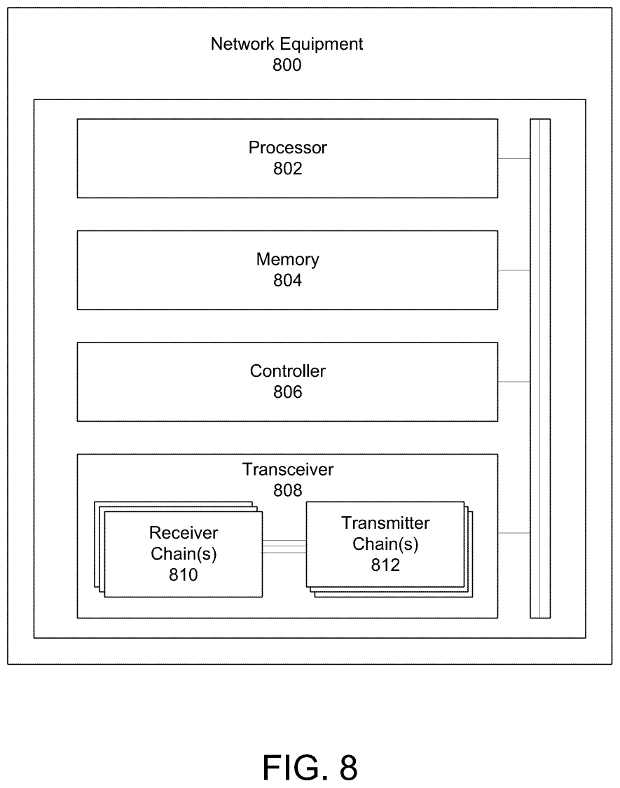

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more AMF functions as described herein (e.g., executing, by the processor 802, instructions stored in the memory 804). Accordingly, the processor 802 may support the communication at the NE 800 in accordance with examples as disclosed herein.

For example, the NE 800 may be configured to support a means for receiving, from a UE, a registration request message, wherein the registration request message is received via a link comprising a satellite.

The NE 800 may be configured to support a means for receiving, from a network function (e.g., the AUSF), an authentication token for the UE. The NE 800 may be configured to support a means for selecting security algorithms based on security capabilities of the UE and the satellite, the security algorithms comprising an integrity algorithm and a ciphering algorithm.

The NE 800 may be configured to support a means for transmitting, towards the UE via the satellite, a response message (e.g., an N2 message) comprising an indication of the security algorithms and a registration accept message in plaintext, wherein the registration accept message comprises the authentication token.

The NE 800 may be configured to support a means for receiving, from the UE (e.g., via the same or a different satellite), a protected NAS request message comprising an authentication result and a data packet.

In some embodiments, the at least one processor is configured to: A) transmit, to the network function (e.g., AUSF), an authentication request message comprising the authentication result; B) receive an authentication response message comprising a verification result; and C) forward the data packet to a second network function based on the verification result.

In certain embodiments, the authentication response message further comprises a second authentication token. In such embodiments, the NE 800 may be configured to transmit a NAS response message comprising the second authentication token and an acknowledgement for the data packet. In certain embodiments, the NAS response message may further indicate a second integrity algorithm and a second ciphering algorithm to protect one or more subsequent NAS messages.

In certain embodiments, the registration accept message indicates a provisional registration of the UE, and the NAS request message is protected with a provisional NAS key associated with the provisional registration. In such embodiments, the NE 800 may be configured to protect the NAS response message using the provisional NAS key.

In some embodiments, the NE 800 may be configured to: A) receive an indication that the satellite supports an AS security context; and B) derive a security key for generating AS keys, based on the indication, where the response message comprises the security key.

In some embodiments, the NE 800 may be configured to: A) determine that the satellite lacks support for an AS security context; and B) select a null integrity algorithm (e.g., the NIA0 algorithm) and a null ciphering algorithm (e.g., the NEA0 algorithm) as the security algorithms, based on the indication.

In some embodiments, the satellite is a S&F satellite, and the response message further indicates a default integrity algorithm (e.g., the NIA0 algorithm) and a default ciphering algorithm (e.g., the NEA0 algorithm) to protect the NAS request message when a communication path to the UE comprises a different satellite.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding/processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

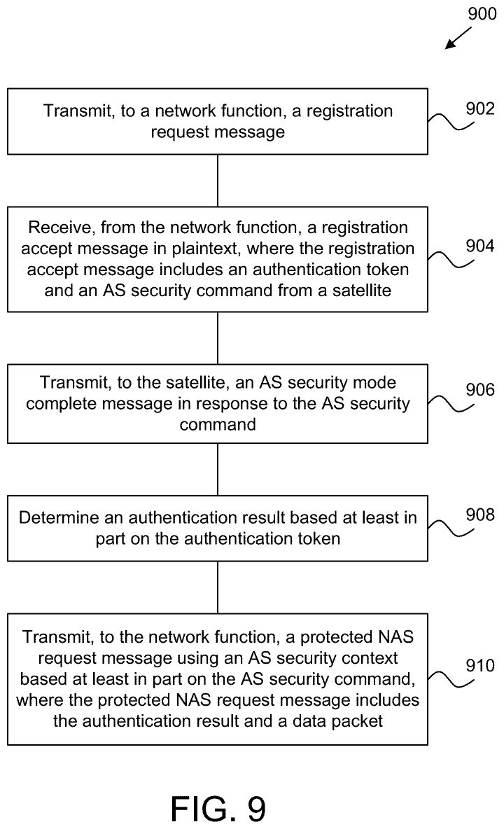

FIG. 9 depicts one embodiment of a method 900 in accordance with aspects of the present disclosure. In various embodiments, the operations of the method 900 may be implemented by a UE, as described herein. In some implementations, the UE may execute a set of instructions to control the function elements of the UE to perform the described functions.

At step 902, the method 900 may include transmitting, to a network function, a registration request message. The operations of step 902 may be performed in accordance with examples as described herein. In some implementations, aspects of the operations of step 902 may be performed by an NE, as described with reference to FIG. 8. In other implementations, aspects of the operations of step 902 may be performed by a UE, as described with reference to FIG. 6.

At step 904, the method 900 may include receiving, from the network function, a registration accept message in plaintext, where the registration accept message includes an authentication token and an AS security command from a satellite. The operations of step 904 may be performed in accordance with examples as described herein. In some implementations, aspects of the operations of step 904 may be performed by an NE, as described with reference to FIG. 8. In other implementations, aspects of the operations of step 904 may be performed by a UE, as described with reference to FIG. 6.

At step 906, the method 900 may include transmitting, to the satellite, an AS security mode complete message in response to the AS security command. The operations of step 906 may be performed in accordance with examples as described herein. In some implementations, aspects of the operations of step 906 may be performed by a UE, as described with reference to FIG. 6.

At step 908, the method 900 may include determining an authentication result based at least in part on the authentication token. The operations of step 908 may be performed in accordance with examples as described herein. In some implementations, aspects of the operations of step 908 may be performed by a UE, as described with reference to FIG. 6.

At step 910, the method 900 may include transmitting, to the network function, a protected NAS request message using an AS security context based at least in part on the AS security command, where the protected NAS request message includes the authentication result and a data packet. The operations of step 910 may be performed in accordance with examples as described herein. In some implementations, aspects of the operations of step 910 may be performed by a UE, as described with reference to FIG. 6.

It should be noted that the method 900 described herein describes one possible implementation, and that the operations and the steps may be rearranged or otherwise modified and that other implementations are possible.

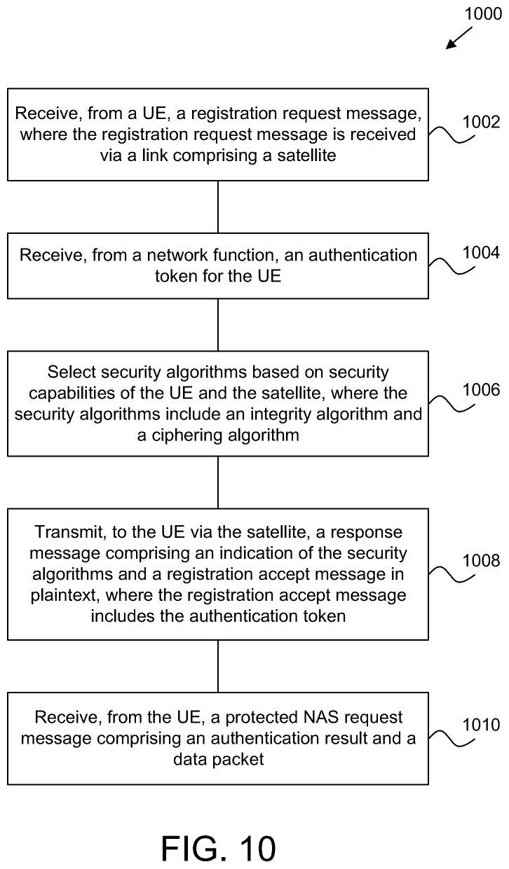

FIG. 10 depicts one embodiment of a method 1000 in accordance with aspects of the present disclosure. In various embodiments, the operations of the method 1000 may be implemented by an AMF, such as a NE or CN node, as described herein. In some implementations, the NE (or CN node) may execute a set of instructions to control the function elements of the NE (or CN node) to perform the described AMF functions.

At step 1002, the method 1000 may include receiving, from a UE, a registration request message, where the registration request message is received via a link comprising a satellite. The operations of step 1002 may be performed in accordance with examples as described herein. In some implementations, aspects of the operation of step 1002 may be performed by a NE, as described with reference to FIG. 8.

At step 1004, the method 1000 may include receiving, from a network function, an authentication token for the UE. The operations of step 1004 may be performed in accordance with examples as described herein. In some implementations, aspects of the operation of step 1004 may be performed by a NE, as described with reference to FIG. 8.

At step 1006, the method 1000 may include selecting security algorithms based on security capabilities of the UE and the satellite, where the security algorithms include an integrity algorithm and a ciphering algorithm. The operations of step 1006 may be performed in accordance with examples as described herein. In some implementations, aspects of the operation of step 1006 may be performed by a NE, as described with reference to FIG. 8.

At step 1008, the method 1000 may include transmitting, to the UE via the satellite, a response message comprising an indication of the security algorithms and a registration accept message in plaintext, where the registration accept message includes the authentication token. The operations of step 1008 may be performed in accordance with examples as described herein. In some implementations, aspects of the operation of step 1008 may be performed by a NE, as described with reference to FIG. 8.

At step 1010, the method 900 may include receiving, from the UE, a protected NAS request message comprising an authentication result and a data packet. The operations of step 1010 may be performed in accordance with examples as described herein. In some implementations, aspects of the operations of step 1010 may be performed by an NE, as described with reference to FIG. 8.

It should be noted that the method 1000 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit, to a network function, a registration request message;
receive, from the network function, a registration accept message in plaintext, wherein the registration accept message comprises an authentication token and an access stratum (AS) security command from a satellite;
transmit, to the satellite, an AS security mode complete message in response to the AS security command;
determine an authentication result based at least in part on the authentication token; and
transmit, to the network function, a protected non-access stratum (NAS) request message using an AS security context based at least in part on the AS security command, wherein the protected NAS request message comprises the authentication result and a data packet.

2. The UE of claim 1, wherein the registration accept message further comprises an indication for using a null integrity algorithm and a null ciphering algorithm to protect the NAS request message.

3. The UE of claim 1, wherein the at least one processor is configured to cause the UE to:
receive a protected NAS response message from the network function, wherein the protected NAS response message comprises a second authentication token and a second AS security command;
determine a second authentication result based at least in part on the second authentication token; and
transmit a second AS security mode complete message in response to the second AS security command.

4. The UE of claim 3, wherein the protected NAS response message further comprises an algorithm selection for an integrity algorithm and a ciphering algorithm to protect one or more subsequent NAS messages.

5. The UE of claim 1, wherein the at least one processor is configured to cause the UE to:
transition to an inactive mode after transmitting the AS security mode complete message;
enter a connected mode prior to transmitting the protected NAS request message; and
applying a default integrity algorithm and a default ciphering algorithm to protect the NAS request message in response to determining that the UE is connected to a different satellite after entering the connected mode.

6. The UE of claim 1, wherein the satellite comprises a store-and-forward satellite, wherein the network function comprises an access and mobility management function (AMF), and wherein the registration accept message indicates a provisional registration of the UE.

7. A processor for wireless communications, comprising:
at least one controller coupled with at least one memory and configured to cause the processor to:
transmit, to a network function, a registration request message;
receive, from the network function, a registration accept message in plaintext, wherein the registration accept message comprises an authentication token and an access stratum (AS) security command from a satellite;
transmit, to the satellite, an AS security mode complete message in response to the AS security command;
determine an authentication result based at least in part on the authentication token; and
transmit, to the network function, a protected non-access stratum (NAS) request message using an AS security context based at least in part on the AS security command, wherein the protected NAS request message comprises the authentication result and a data packet.

8. The processor of claim 7, wherein the registration accept message further comprises an indication for using a null integrity algorithm and a null ciphering algorithm to protect the NAS request message.

9. The processor of claim 7, wherein the at least one controller is configured to cause the processor to:
receive a protected NAS response message from the network function, wherein the protected NAS response message comprises a second authentication token and a second AS security command;
determine a second authentication result based at least in part on the second authentication token; and
transmit a second AS security mode complete message in response to the second AS security command.

10. The processor of claim 9, wherein the protected NAS response message further comprises an algorithm selection for an integrity algorithm and a ciphering algorithm to protect one or more subsequent NAS messages.

11. An apparatus comprising an access and mobility management function (AMF), the apparatus comprising:
at least one memory; and
at least one processor coupled with the at least one memory and configured to cause the AMF to:
receive, from a user equipment (UE), a registration request message, wherein the registration request message is received via a link comprising a satellite;
receive, from a network function, an authentication token for the UE;
select security algorithms based on security capabilities of the UE and the satellite, the security algorithms comprising an integrity algorithm and a ciphering algorithm;
transmit, to the UE via the satellite, a response message comprising an indication of the security algorithms and a registration accept message in plaintext, wherein the registration accept message comprises the authentication token; and
receive, from the UE, a protected non-access stratum (NAS) request message comprising an authentication result and a data packet.

12. The apparatus of claim 11, wherein the at least one processor is configured to cause the AMF to:
transmit, to the network function, an authentication request message comprising the authentication result;
receive an authentication response message comprising a verification result; and
forward the data packet to a second network function based on the verification result.

13. The apparatus of claim 12, wherein the authentication response message further comprises a second authentication token, and wherein the at least one processor is configured to cause the AMF to transmit a NAS response message comprising the second authentication token and an acknowledgement for the data packet.

14. The apparatus of claim 13, wherein the registration accept message indicates a provisional registration of the UE, wherein the NAS request message is protected with a provisional NAS key associated with the provisional registration, and wherein the at least one processor is configured to cause the AMF to protect the NAS response message using the provisional NAS key.

15. The apparatus of claim 13, wherein the NAS response message further indicates a second integrity algorithm and a second ciphering algorithm to protect one or more subsequent NAS messages.

16. The apparatus of claim 11, wherein the at least one processor is configured to cause the AMF to:
receive an indication that the satellite supports an AS security context; and
derive a security key for generating AS keys, based on the indication, wherein the response message comprises the security key.

17. The apparatus of claim 11, wherein the at least one processor is configured to cause the AMF to:
determine that the satellite lacks support for an AS security context; and
select a null integrity algorithm and a null ciphering algorithm as the security algorithms, based on the indication.

18. The apparatus of claim 11, wherein the satellite comprises a store-and-forward satellite, and wherein the response message further indicates a default integrity algorithm and a default ciphering algorithm to protect the NAS request message when a communication path to the UE comprises a different satellite.

19. A method performed by an access and mobility management function (AMF), the method comprising:
receiving, from a user equipment (UE), a registration request message, wherein the registration request message is received via a link comprising a satellite;
receiving, from a network function, an authentication token for the UE;
selecting security algorithms based on security capabilities of the UE and the satellite, the security algorithms comprising an integrity algorithm and a ciphering algorithm;
transmitting, to the UE via the satellite, a response message comprising an indication of the security algorithms and a registration accept message in plaintext, wherein the registration accept message comprises the authentication token; and
receiving, from the UE, a protected non-access stratum (NAS) request message comprising an authentication result and a data packet.

20. The method of claim 19, further comprising:
transmitting, to the network function, an authentication request message comprising the authentication result;
receiving an authentication response message comprising a verification result; and
forwarding the data packet to a second network function based on the verification result.
